(19) United States
(12) Patent Application Publication
(10) Pub. No.: US 2005/0233173 A1
(43) Pub. Date: Oct. 20, 2005

(54) Intermediate transfer recording medium and printed product

(76) Inventors: Kozo Odamura, Shinjuku-ku (JP); Takayuki Imai, Shinjuku-ku (JP); Shinichi Yunoki, Shinjuku-ku (JP)

Correspondence Address: SEYFARTH SHAW, 55 EAST MONROE STREET, SUITE 4200, CHICAGO, IL, 60603-5803, US

(21) Appl. No.: 10/614,943

(22) Filed: Jul. 8, 2003

(30) Foreign Application Priority Data
Jul. 11, 2002 (JP) 2002-203247
Jul. 11, 2002 (JP) 2002-203248

(51) Int. Cl. G11B 5/00

(52) U.S. Cl. 428/800; 428/846

(57) ABSTRACT

An intermediate transfer recording medium is such one wherein a transferable layer is peelably provided on a substrate, an image is formed on a receptor layer partially constituting the transferable layer by thermal transfer, and then the transferable layer is retransferred onto a transfer-receiving material. In the intermediate transfer recording medium of a first aspect, the peeling strength “a” of the image formed region and the peeling strength “b” of the image non-formed region, the regions being included in the transferable portion after the image is thermally transferred on the receptor layer, satisfies the following inequality (1): |a−b|≦b/2. In the intermediate transfer recording medium of a second aspect, the peeling strength of the transferable portion at the time of peeling it from the substrate is from 19.30442 to 96.52215 mN/cm (5 to 25 gf/inch), and the thickness of the transferable portion is 3 μm or less.

### BACKGROUND OF THE INVENTION

1. Field of the Invention

The present invention relates to an intermediate transfer recording medium where in a transferable portion having a multilayered structure comprising a receptor layer is peelably provided on a substrate film, and a printed product obtained by forming an image on the receptor layer in the transferable portion by thermal transfer and then retransferring the formed image, together with the transferable portion, from the intermediate transfer recording medium to a transfer-receiving material.

2. Description of the Related Art

Hitherto, thermal transfer recording has widely been used as a simple printing method. The thermal transfer recording is a method of laying a thermal transfer sheet wherein a colorant layer is disposed on one surface of a substrate film on a thermal transfer image-receiving sheet which may optionally have an image receptor layer and then heating the back surface of the thermal transfer sheet image wise by a heating device such as a thermal head to selectively transfer the colorant contained in the colorant layer, and thereby forming an image on the thermal transfer image-receiving sheet.

The thermal transfer recording is classified into heat melting transfer recording method and sublimation transfer recording method. The heat melting transfer recording method is an image forming method of using a thermal transfer sheet having a structure wherein a heat meltable ink layer having a colorant, such as pigment, dispersed in a binder, such as heat meltable wax or resin, is carried on a substrate film, such as a PET film; and applying an energy corresponding to image information to the heat meltable ink layer with a heating device, such as a thermal head so as to transfer the colorant together with the binder onto a thermal transfer image-receiving sheet which has a substrate film, such as paper or a plastic sheet and may optionally have an image receptor layer on the substrate. The image based on the heat melting transfer recording method has high density and superior sharpness and is suitable for binary recording of characters or the like.

On the other hand, the sublimation transfer recording method is an image recording method of using a thermal transfer sheet having a structure wherein a dye layer having a dye, which has a nature of being thermally transferred mainly by sublimation, dissolved or dispersed in a resin binder is carried on a substrate film, such as a PET film; and applying an energy corresponding to image information to the dye layer with a heating device, such as a thermal head so as to transfer only the dye onto a thermal transfer image-receiving sheet which has a substrate film, such as paper or a plastic sheet and may optionally have a dye-receiving layer on the substrate film.

The sublimation transfer recording method makes it possible to control the transfer amount of the dye correspondingly to the amount of the applied energy, and therefore a gradation-image can be formed by controlling the density of image for each dot of the thermal head. Moreover, the used colorant is dye; therefore, the formed image has transparency, and further the reproducibility of any intermediate color is satisfactory when dyes having different colors are overlapped with each other. Accordingly, when thermal transfer sheets having different colors such as yellow, magenta, cyan and black are used to transfer dyes in the respective colors, in an overlapping form, onto a thermal transfer image-receiving sheet, a high-quality, photographic-tone full-color (or natural-color) image, which is superior in reproducibility of intermediate colors, can be formed.

Specific uses of such a thermal transfer image-receiving sheet according to the thermal transfer recording are wide-ranging. Typical examples thereof include printing proof; image output; output of designs such as CAD and CAM; output from various analyzers or measuring devices for medical care such as a computer axial tomography or an endoscope; a substitute for an instant photograph; output of a facial photograph to an identification certificate, an ID card, a credit card, and some other cards; and supply of an attraction for preparing a composite photograph or a memorial photograph in facilities for amusement, such as an amusement park, an amusement arcade, a museum and an aquarium.

Following the diversification of the uses as described above, a desire for forming a thermal transfer image onto any object has been raised. As a measure for the desire, suggested is a method of using an intermediate transfer recording medium having a structure wherein a transferable receptor layer is peelably provided onto a substrate. There has been suggested a method wherein a colorant such as dye or pigment is transferred to a receptor layer of the intermediate transfer recording medium by using a thermal transfer sheet having a dye layer or a heat meltable ink layer to form an image, and subsequently the receptor layer of the intermediate transfer recording medium is transferred to a transfer-receiving material under heating which may be optionally performed (for example, Japanese Patent Application Laid-Open (JP-A) No. 62-238791).

When the above-mentioned intermediate transfer recording medium is used, an image is transferred together with a receptor layer onto a transfer-receiving material. Hence, the intermediate transfer recording medium is favorably used for a transfer-receiving material onto which a high-quality image cannot be directly formed because a coloring material hardly migrates thereto or a transfer-receiving material which is liable to fuse and adhere to any colorant layer at the time of thermal transfer. The intermediate transfer recording medium is favorably used for the preparation of a printed product, for example, an identification certificate such as a passport, or a card such as a credit card or an ID card.

JP-A No. 11-263079 as a prior art relates to an intermediate transfer recording medium wherein a transferable portion having at least a receptor layer is peelably provided on a substrate film, and discloses that the peeling strength for peeling the transferable portion from the substrate film is from 38.60886 to 579.13287 mN/cm (10 to 150 gf/inch) and the transferable portion has a thickness of 3 μm or more. Since the peeling strength is set to a value of 38.60886 to 579.13287 mN/cm (10 to 150 gf/inch), tailing or burr liable to be caused when the peeling strength is too small is not generated, or peeling of the film or chipping liable to be caused when the peeling strength is large is not generated even if the transferable portion has a multilayered structure.

### SUMMARY OF THE INVENTION

In the case that an intermediate transfer recording medium as described above is used to form a thermal transfer image onto a receptor layer and then a continuous area of a receptor layer in which the region where the thermal transfer image is formed (i.e., the image formed region) and the region where the thermal transfer image is not formed (i.e., the image non-formed region) are coexisting, is transferred to a transfer-receiving material, a large difference in the peeling strength required when the receptor layer is peeled from the substrate film (i.e., adhesive force against the peel) is generated between the image formed region and the image non-formed region. In other words, the peeling strength of the image formed region in the receptor layer is large and thus the surface of the image formed region becomes rough at the time of peeling the receptor layer from the substrate film of the intermediate transfer recording medium, so that surface unevenness is generated. Consequently, the image formed region in the receptor layer, which is transferred on the transfer-receiving material, has a large difference in external appearance from the receptor layer corresponding to the image non-formed region, this region being smooth. Thus, a problem that the value or quality of the final product lowers a rises. For example, the image formed region having a mat surface is present adjacently to the image non-formed region having a high glossiness. As a result, a desire that glossiness is necessary for the whole of the image-transferred area is not met.

In the case that the thermal transfer image of the image formed region is a highly dense image or a solid image of mixed color, a high energy is applied to an image formed region when the image is printed. Consequently, a problem that the image formed region is not peeled from the substrate film is also caused.

However, in the JP-A No. 11-263079, no attention is paid to difference in the peeling strength between the image formed region and the image non-formed region in the transferable portion.

There is also caused a different problem as follows: when an intermediate transfer recording medium is used to transfer its receptor layer onto a transfer-receiving material in which an information-reading section from which information is read by means of a mechanical device, such as a magnetic tape or a bar code portion, is formed, the receptor layer is transferred onto the whole of the transfer-receiving material, which includes the information-reading section, so that the information-reading section is covered with the receptor layer; thus, there are caused inconveniences such that the information is wrongly read or is never read by means of the mechanical device.

However, the JP-A No. 11-263079 never discloses any damage to the transfer-receiving material wherein the transferable portion is to be transferred, or any effect on reading-suitability of the information-reading section.

Accordingly, a first object of the present invention is to provide an intermediate transfer recording medium producing the following advantageous effect: at the time of forming a thermal transfer image on a receptor layer of the intermediate transfer recording medium and subsequently transferring the receptor layer consisting of an image formed region and an image non-formed region, as a whole, onto a transfer-receiving material, no large difference in surface natures, such as external appearance and material feel, is generated between the image formed region and the image non-formed region in the receptor layer after being transferred onto the transfer-receiving material; the entire face of the receptor layer transferred on the transfer-receiving material is smooth; and the resultant printed product has a high product value.

A second object of the present invention is to provide an intermediate transfer recording medium having a structure wherein a receptor layer is peelably provided on a substrate film and producing the following advantageous effect: even when this intermediate transfer recording medium is used to transfer the receptor layer onto a transfer-receiving material having an information-reading section, from which information can be mechanically read, in such a manner that the receptor layer will cover the entire face of the transfer-receiving material including the information-reading section, no effect is given on the reading-suitability of the information-reading section.

Furthermore, a third object of the present invention is to provide a printed product wherein the reading-suitability of its information-reading section is good by use of an intermediate transfer recording medium which can attain the second object.

In order to attain the first object, the intermediate transfer recording medium provided by the present invention is an intermediate transfer recording medium comprising at least a substrate and a transferable portion which is peelably provided on the substrate, the transferable portion having a multilayered structure comprising at least a receptor layer and a peelable layer which is interposed between the receptor layer and the substrate and which facilitates the peel of the transferable portion from the substrate,

wherein at the time of peeling the transferable portion from the substrate after forming an image onto the receptor layer of the intermediate transfer recording medium by thermal transfer, the peeling strength of the transferable portion, measured by the peeling test at 180° angles in accordance with JIS Z0237, satisfies a relationship defined by the following inequality (1):
|a−b|≦b/2 (1)
wherein the peeling strength “a” is defined as the peeling strength of an image formed region in the transferable portion and the peeling strength “b” is defined as the peeling strength of an image non-formed region in the transferable portion.

In this intermediate transfer recording medium, the peeling strength after forming an image onto the receptor layer of the transferable portion by thermal transfer is adjusted to set the difference (absolute value) in the peeling strength between the image formed region and the image non-formed region to ½ or less of that of the image non-formed region. Since the difference in the peeling strength between the image formed region and the image non-formed region is made small by this restriction of the peeling strength, it is possible to prevent a variation in the surface nature of the transferable portion transferred to a transfer-receiving material from being generated, make the whole of the transferable portion transferred to the transfer-receiving material smooth or even, and avoid a drop in the product value of a printed product to be obtained.

In order to attain the second object, the intermediate transfer recording medium provided by the present invention comprising at least a substrate and a transferable portion which is peelably provided on the substrate, the transferable portion having a multilayered structure comprising at least a receptor layer and a peelable layer which is interposed between the receptor layer and the substrate and which facilitates the peeling of the transferable portion from the substrate,

wherein at the time of peeling the transferable portion from the substrate, the peeling strength of the transferable portion, measured by the peeling test at 180° angles in accordance with JIS Z0237, is from 19.30442 to 96.52215 mN/cm (5 to 25 gf/inch), and the thickness of the transferable portion is 3 μm or less.

Since the layer thickness of the transferable portion of this intermediate transfer recording medium is controlled to be thin, a printed product wherein the reading-suitability of an information-reading section is not lowered can be obtained. Furthermore, the resistance force (peeling strength) of the transferable portion when this part is peeled from the substrate film is made low. Therefore, even if the layer thickness of the transferable portion is made small when the transferable portion is transferred onto a transfer-receiving material, the transferable portion does not chip easily and further layer-peeling of the surface of the substrate of the intermediate transfer recording medium is not caused.

In any one of the intermediate transfer recording media which attain the first or second object can comprise, the peelable layer can contain are lease material in order to adjust the peeling strength. It is preferred to use, as the release material, one or more selected from the group consisting of silicone-modified resins and acryl-styrene copolymer resins.

In order to attain the third object, the printed product provided by the present invention is that obtained by performing thermal transfer to form an image on the receptor layer of the transferable portion arranged in the intermediate transfer recording medium making it possible to attain the second object and then transferring the transferable portion including the image onto an information-reading section of a transfer-receiving material.

In this printed product, the information-reading section is covered with the transferable portion on which the image is carried, but the information can be read without any trouble.

In the case that the printed product is in such a form that information which should be recorded in the information-reading section can additionally be recorded from above the transferable portion or the recorded information can be changed therefrom, information can be newly recorded or can be added or the recorded information can be changed even after the transferable portion is transferred to the information-reading section.

### BRIEF DESCRIPTION OF THE DRAWINGS

In the accompanying drawings,

FIG. 1 is a schematic sectional view illustrating an embodiment of the intermediate transfer recording medium of the present invention;

FIG. 2 is a schematic sectional view illustrating another embodiment of the intermediate transfer recording medium of the present invention; and

FIG. 3 is a schematic plan view illustrating an embodiment of the printed product of the present invention.

### DETAILED DESCRIPTION OF THE PREFERRED EMBODIMENTS

FIGS. 1 and 2 are schematic sectional views each illustrating an example of a layer structure common to a first aspect and a second aspect of the present invention, which will be described later. In FIG. 1, an intermediate transfer recording medium 1 is an example wherein a peelable layer 3 and a receptor layer 4 are successively laminated on a substrate 2. In other words, a transferable portion 5 having a bilayer structure composed of the peelable layer 3 and the receptor layer 4 is peelably disposed on the substrate 2. In FIG. 2, an intermediate transfer recording medium 1 is an example wherein a peelable layer 3, an intermediate layer 6 and a receptor layer 4 are successively laminated on a substrate 2. In other words, a transferable portion 5 having a three-layer structure composed of the peelable layer 3, the intermediate layer 6 and the receptor layer 4 is peelably disposed on the substrate 2.

FIG. 3 is a schematic plan view illustrating an example of a printed product (i.e., a card) prepared by use of an intermediate transfer recording medium according to the first or second aspect of the present invention. In FIG. 3, this card 7 is a card obtained by arranging, on one surface thereof, an information-reading section 8 made of a magnetic stripe, a photographic tone image 9 showing a portrait of a card owner, and binarized images (character images) 10 for showing character data (such as an ID number) at predetermined positions, and then transferring the transferable portion 5 onto the whole of the surface so as to be covered with this part 5.

First Aspect of the Present Invention

The intermediate transfer recording medium according to the first aspect of the present invention is composed of at least a substrate and a transferable portion which is peelably provided on the substrate, the transferable portion having a multilayered structure comprising at least a receptor layer and a peelable layer which is interposed between the receptor layer and the substrate and which facilitates the release of the transferable portion from the substrate,

wherein at the time of peeling the transferable portion from the substrate after forming an image onto the receptor layer of the intermediate transfer recording medium by thermal transfer, the peeling strength of the transferable portion, measured by the peeling test at 180° angles in accordance with JIS Z0237, satisfies a relationship defined by the following inequality (1):
|a−b|≦b/2 (1)
wherein the peeling strength “a” is defined as the peeling strength of an image formed region in the transferable portion and the peeling strength “b” is defined as the peeling strength of an image non-formed region in the transferable portion.

The following will describe respective elements which constitute the intermediate transfer recording medium of the first aspect.

Substrate Film:

As the substrate 2 constituting the intermediate transfer recording medium, the same film-form or sheet-form substrate as used in any conventional intermediate transfer recording medium can be used without being modified. The kind thereof is not particularly limited. Specific and preferred examples of the substrate film include thin papers such as glassine paper, condenser paper and paraffin paper; and oriented or non-oriented films made of a plastic, for example, a highly heat-resistant polyester (such as polyethylene terephthalate, polyethylene naphthalate, polybutylene terephthalate, polyphenylene sulfide, polyetherketone, or polyethersulfone), polypropylene, polycarbonate, cellulose acetate, a polyethylene derivative, polyvinyl chloride, polyvinylidene chloride, polystyrene, polyamide, polyimide, polymethylpentene, and ionomer. A composite film or composite sheet wherein two or more kinds among these materials are laminated may also be used.

The thickness of the substrate can be appropriately selected dependently on the used material so as to make physical properties (such as strength and heat resistance) of the substrate appropriate. Usually, the thickness for use is preferably from about 1 to 100 μm.

If necessary, in the intermediate transfer recording medium of the present invention, a rear layer, which has been known hitherto, may be formed on the back face of the substrate, that is, the face of the substrate opposite to the face on which the receptor layer is formed in order to prevent bad effects, such as sticking and wrinkle, due to heat from a thermal head or a heat roll as a device for retransferring the transferable portion in which an image is formed onto a transfer-receiving material.

Peelable Layer:

In the intermediate transfer recording medium of the present invention, the receptor layer is formed through the peelable layer 3 on the substrate. By forming the peelable layer in the intermediate transfer recording medium, the peeling strength between the receptor layer and the substrate is appropriately adjusted so that the transferable portion (transferable layer) composed of two or more layers including the receptor layer as a main layer can be surely and easily retransferred from the intermediate transfer recording medium to a transfer-receiving material.

The intermediate transfer recording medium of the present invention has a structure wherein the transferable portion composed of two or more layers comprising the receptor layer and the peelable layer is peelably provided on the substrate. When the transferable portion is peeled from the substrate, the peeling is carried out in the boundary between the substrate and the peelable layer in many cases.

The peelable layer essentially has a function of holding the transferable portion on the intermediate transfer recording medium not to be dropped out from the substrate up to the stage at which an image is formed on the receptor layer of the transferable portion by thermal transfer and a function of releasing the transferable portion easily from the substrate at the stage at which the transferable portion is transferred onto a transfer-receiving material after the formation of the image. The peelable layer may have functions other than the above functions.

According to the first aspect of the present invention, in order that the change in adhesion at a boundary between the peelable layer and the substrate film may remain small between the times before and after thermal transfer even in the region to which heat and pressure at the process of the thermal transfer are applied in the transferable portion where an image is formed by the thermal transfer, the ratio of the peeling strength “a” required for peeling the transferable portion in the region where the image is formed (image formed region) from the substrate to the peeling strength “b” required for peeling the transferable portion in the region where the image is not formed (image non-formed region) from the substrate (i.e., the ratio of a/b) is set to 1/2≦a/b≦2/1. For this reason, a difference in surface nature between the image formed region and the image non-formed region is small after the transferable portion including both the regions is transferred onto a transfer-receiving material. In short, the entire surface of the transferable portion transferred onto the transfer-receiving material becomes smooth.

In order to allow the above-mentioned relationship about the peeling strength to be satisfied, the material constituting the peelable layer is appropriately selected. As the material constituting the peelable layer, a release material may be used. Examples of the release material include various thermoplastic resins modified with siloxane such as siloxane-modified thermoplastic resins (silicone-modified resins) or the like, acryl-styrene copolymer resins, and fluorine-contained resins. The silicone-modified resins can be obtained by bonding reactive silicone oil having a hydroxyl group, amino group, epoxy group, vinyl group, isocyanate group, carboxylic group or some other group to thermoplastic resin having a functional group optionally with using a crosslinking agent such as polyamine, polyol or polyisocyanate. Preferred examples of the release material used in the present invention include silicone-modified polyvinyl acetal resins such as silicone-modified polyvinyl butyral resin and silicone-modified polyvinyl actoacetal resin; silicone-modified polyester resins; silicone-modified cellulose resins; and acryl-styrene copolymer resins.

The peelable layer can be formed by mixing a release material as exemplified above with a thermoplastic resin such as acryl resin, polyester resin, polyurethane resin, cellulose resin (such as cellulose acetate), vinyl chloride-vinyl acetate copolymer, or cellulose nitrate. The peelable layer can be made of only the above-mentioned release material. When the peeling strength required for peeling the transferable portion in the image formed region from the substrate is defined as the peeling strength “a” and the peeling strength required for peeling the transferable portion in the image non-formed region from the substrate is defined as the peeling strength “b”, in all cases it is necessary to adjust the composition of the peelable layer in such a manner that the relationship represented by the inequality (1) can be satisfied.

The release material as described above is not a material such as a lubricant, for example, any one of various waxes, surfactants and metal soaps. That is, the release material is not a material which melts by heating so as to ooze out to the substrate side of the peelable layer or the boundary face on the receptor layer side of the peelable layer, but is a material which softens by heating so as to improve the peeling ability with respect of the substrate and which gives only a small change in the peeling strength between the substrate and the peelable layer comprising the release material before and after the heating when the temperature of the material returns to room temperature after the heating.

The peeling strength required for peeling the transferable portion from the substrate is a value obtained by laying the intermediate transfer recording medium wherein the transferable portion having a multilayered structure containing at least the receptor layer is peelably provided on the substrate on a thermal transfer sheet wherein a colorant layer is provided on a substrate in such a manner that the receptor layer and the colorant layer face with each other, forming an image onto the receptor layer by means of a heating device such as a thermal head, and then measuring the peeling strength required for peeling the transferable portion of the intermediate transfer recording medium from the substrate at room temperature by the peeling test at 180° angles in accordance with JIS Z0237.

When the peeling strength “b” required for peeling the transferable portion in the image non-formed region from the substrate is, for example, about 84.93949 mN/cm (22 gf/inch), the peeling strength “a” required for peeling the transferable portion in the image formed region from the substrate is adjusted to about 42.46974 to 127.40923 mN/cm (about 11 to 33 gf/inch).

The peelable layer can be formed by dissolving or dispersing a material as described above in a suitable solvent to prepare a coating liquid for the peelable layer, applying this liquid to a substrate by gravure printing, screen printing, reverse coating using a gravure plate, or some other method, and then drying the same. The thickness of the peelable layer after the drying is about from 0.05 to 10 μM.

Receptor Layer:

The receptor layer 4 is disposed as a part of the transferable portion, which partially constitutes the intermediate transfer recording medium, so as to be positioned as a topmost layer. On this receptor layer, an image is formed from a thermal transfer sheet having a colorant layer by thermal transfer. Then the transferable portion of the intermediate transfer recording medium in which the image is formed is transferred onto a transfer-receiving material, thereby forming a printed product.

Thus, as the material for forming the receptor layer, there can be used any resin material that is known in the prior art and easily receives a thermally-migratable colorant such as a sublimating dye or a heat meltable ink. Preferred examples of the resin material include polyolefin resins such as polypropylene; halogenated resins such as polyvinyl chloride and polyvinylidene chloride; vinyl resins such as polyvinyl acetate, vinyl chloride-vinyl acetate copolymer, ethylene-vinyl acetate copolymer and polyacrylic ester; polyester resins such as polyethylene terephthalate and polybutylene terephthalate; polystyrene resins; polyamide resins; copolymer resins made from an olefin, such as ethylene or propylene, and another vinyl polymer; ionomer; cellulose resins such as cellulose diastase; and polycarbonate. Particularly, preferred are vinyl chloride resins, acryl-styrene based resins and polyester resins.

It is preferred to use a resin material having adhesive ability, such as vinyl chloride-vinyl acetate copolymer, to form the receptor layer.

The receptor layer can be formed by using one or more materials selected from the above-mentioned materials and, if necessary, various additives, dissolving or dispersing these materials in a suitable solvent such as water or organic solvent to prepare a coating liquid for the receptor layer, applying this solution by gravure printing, screen printing, reverse coating using a gravure plate, or some other method, and then drying the same. The thickness thereof after the drying is about from 0.5 to 10 μm.

Intermediate Layer:

In the intermediate transfer recording medium of the present invention, the intermediate layer 6 can be formed as a layer which constitutes the transferable portion between the peelable layer and the receptor layer. It is possible to impart superior functions to the transferable portion of the intermediate transfer recording medium by making the intermediate layer cause various effects. For example, it is possible to incorporate an ultraviolet absorber into the intermediate layer to improve the light resistance of the image, incorporate a fluorescent substance into the layer to improve forgery-preventing ability, or improve the adhesive property between the peelable layer and the receptor layer.

It is possible to use, as the ultraviolet absorber, a known organic ultraviolet absorbent such as a benzophenone type compound, a benzotriazole type compound, anilide oxalate type compound, a cyanoacrylate type compound, or a salicylate type compound. It is also possible to incorporate, into the intermediate layer, an inorganic ultraviolet absorbent made of inorganic fine particles having ultraviolet ray absorbing ability, such as an oxide of zinc, titanium, cerium, tin or iron.

The fluorescent substance is a substance which emits fluorescence by ultraviolet irradiation, and can be roughly classified into inorganic and organic fluorescent substances. From another viewpoint, the fluorescent substance can be roughly classified into a colorless fluorescent substance, which hardly or never absorbs visible rays, and a colored fluorescent substance having a certain measure of an absorption band in the visible ray range. In the present invention, it is preferable to use the colorless fluorescent substance, which hardly or never absorbs visible rays.

It is possible to use, as the colorless inorganic fluorescent substance, a pigment obtained by adding a metal element such as Mg, Ag, Cu, Sb or Pb, a rare earth element such as a lanthanoid as an activator o a crystal (as a main component) made of an oxide, a sulfide, a silicate, a phosphate or a tungstate of Ca, Ba, Mg, Zn, Cd or some other metal, and then calcining the resultant.

It is possible to use, as the organic fluorescent substance, derivatives such as a diaminostylbene disulfonic acid derivative, an imidazole derivative, a coumarin derivative, a triazole derivative, a carbazole derivative, a pyridine derivative, a naphthalic acid derivative or an imidazolone derivative; a dye such as fluorescein or eosin; a compound having a benzene ring, such as anthracene; or some other compound.

Examples of the resin constituting the intermediate layer include polyurethane resin, acrylic resin, polyethylene resin, butadiene rubber and epoxy resin. The thickness of the intermediate layer after being dried is from about 0.5 to 5 μm. The method for forming the intermediate layer may be the same as that of the receptor layer.

Transfer-Receiving Material:

The transferable portion wherein a thermal transfer image is formed is transferred from the above-mentioned intermediate transfer recording medium to a transfer-receiving material. The transfer-receiving material can be made of material such as natural pulp paper, coated paper, tracing paper, plastic which does not deform by heat generated when the image is retransferred from the intermediate transfer recording medium, glass, metal, ceramic, wood or cloth. The kind thereof is not particularly limited.

The kind of the natural pulp paper is not particularly limited. Examples thereof include fine-quality paper, art paper, light coated paper, slightly coated paper, coated paper, cast-coated paper, synthetic resin or emulsion impregnated paper, synthetic rubber latex impregnated paper, synthetic resin internally-added paper, and thermal transfer paper.

The shapes or use purposes of the transfer-receiving material are as follows: notes such as a stock certificate, a bill, a bond, passbook, a ticket, gambling tickets such as a betting ticket, a revenue stamp, a stamp, an admission ticket and other tickets; cards such as a cash card, a credit card, a prepaid card, a member's card, a greeting card, a post card, a business card, a driver's license card, an IC card and an optical card; cases or bags such as a carton and a container; printed products and booklets such as a bookmark, a calendar, a poster, an OHP sheet, a slide film, a passport, a pamphlet, a menu, various sample books and an album; articles of stationery such as an envelope and report paper; articles for shops such as POP articles, a tag, a coaster, a display screen and a nameplate; exterior and interior materials such as a building material and a panel; ornaments such as cosmetics, a wristwatch and a lighter; accessories such as an emblem and a key; clothing items such as a cloth, clothes and shoes; devices such as a radio, a television, a desk-top calculator, a keyboard and OA apparatus; and various outputs such as a computer graphic output and a medical image output. The kind thereof is not particularly limited.

Preparation of a Printed Product:

The intermediate transfer recording medium and the transfer-receiving material described above are used to form a thermal transfer image onto the receptor layer of the intermediate transfer recording medium, and subsequently the thermal transfer image, together with the transferable portion including the image formed region and the image non-formed region, is retransferred to the transfer-receiving material, whereby an printed product is formed.

The transferable portion of the intermediate transfer recording medium may be transferred to a part of the image-receiving surface of the transfer-receiving material. Preferably, the transferable portion is transferred to the whole of the image-receiving surface of the transfer-receiving material.

In the case that at the time of using the intermediate transfer recording medium of the first aspect to form a thermal transfer image on the receptor layer of the transferable portion, if the peeling strength “a” required for peeling the transferable portion in the image formed region from the substrate and the peeling strength “b” required for peeling the transferable portion in the image non-formed region from the substrate satisfy the following inequality (1), the difference between the peeling strength “a” and the peeling strength “b” is made small.
|a−b|≦b/2 (1)
Thus, it is possible to prevent the generation of a difference between the image formed region of the transferable portion and the image non-formed region thereof in the surface nature of the transferable portion after being transferred to the transfer-receiving material. Accordingly, the entire surface of the transferable portion transferred to the transfer-receiving material is smooth and the product value of the resultant printed product does not lower.

When the relationship of the peeling strength defined by the inequality (1) falls into |a−b|>b/2 and “a” is larger than “b” about, the adhesion between the image formed region of the transferable portion and the substrate is too high. Consequently, unevenness is generated in the surface which is revealed by peeling this area from the substrate, so that a mat tone is remarkable. When the relationship of the peeling strength defined by the inequality (1) falls into |a−b|>b/2 and “a” is smaller than “b”, the adhesion between the image formed region of the transferable portion and the substrate is low. Consequently, the transferable portion is peeled from the substrate during the handling of the intermediate transfer recording medium before the transferable portion is transferred to the transfer-receiving material, or other troubles are easily caused.

A colorant is transferred from a colorant layer, such as a dye layer or a heat meltable ink layer, of the thermal transfer sheet to any position in the receptor layer of the intermediate transfer recording medium, wherein the transferable portion having a multilayered structure comprising at least the receptor layer and the transferable layer is peelably provided on the substrate, by means of a heating device such as a thermal head. In this way, an image is formed. Next, the image formed in the transferable portion of the intermediate transfer recording medium, together with the transferable portion, is retransferred to a transfer-receiving material by means of a heating device such as a heat roll. In this way, a printed product is formed. If necessary, at this retransferring stage, the transferring of the transfer layer may be conducted under heating, as well.

In the first aspect, the peeling strengths “a” and “b” after an image is formed on the receptor layer of the transferable portion by thermal transfer are greatly affected by the structure of the intermediate transfer recording medium, in particular, the composition and the thickness of the peelable layer included in the transferable layer. Besides, the peeling strengths are varied by heating or pressing conditions when the thermal transfer image is formed on the receptor layer of the transferable portion.

Therefore, in order to carry out the first aspect of the present invention certainly, it is preferable to construct a thermal transfer recording system comprising an intermediate transfer recording medium having peeling strengths “a” and “b” satisfying the inequality (1) under predetermined range of the heating condition, and a heating device which can set said heating conditions.

### EXAMPLE A SERIES

Examples about the first aspect will be described hereinafter. The word “part(s)” means part(s) by weight.

### Example A1

First, a transparent polyethylene terephthalate having a thickness of 12 μm was used as a substrate film, and the following coating liquid for peelable layer was applied onto the surface of the film with a gravure coater and then dried to form a peelable layer having a thickness of 1.5 μm in a dried state on the entire surface of the substrate film.

<Coating Liquid for Peelable Layer>

Silicone-modified polyester resin: 4 parts
Polyester resin: 100 parts
Methyl ethyl ketone: 50 parts
Toluene: 50 parts

Next, the following coating liquid for receptor layer was applied onto the peelable layer with a gravure coater and then dried to form a receptor layer having a thickness of 2.0 μm a dried state. In this way, an intermediate transfer recording medium of Example A1 was prepared.

<Coating Liquid for Receptor Layer>

Vinyl chloride-vinyl acetate copolymer: 40 parts
Acrylsilicone: 1.5 part
Methyl ethyl ketone: 50 parts
Toluene: 50 parts

### Example A2

The substrate film same as in Example A1 was used, and the coating liquid for peelable layer having the following composition which was substituted for that in Example A1 was applied onto the entire surface of the substrate film by means of a gravure coater, and dried to form a peelable layer having a thickness of 1.5 μm after being dried. As to the rest, the same way as in Example A1 was carried out to prepare an intermediate transfer recording medium of Example A2.

<Coating Liquid for Peelable Layer>

Acryl-styrene copolymer resin: 25 parts
Polyester resin: 100 parts
Methyl ethyl ketone: 50 parts
Toluene: 50 parts

### Comparative Example A1

The substrate film same as in Example A1 was used, and the coating liquid for peelable layer having the following composition which was substituted for that in Example A1 was applied onto the entire surface of the substrate film by means of a gravure coater, and dried to form a peelable layer having a thickness of 1.5 μm after being dried. As to the rest, the same way as in Example A1 was carried out to prepare an intermediate transfer recording medium of Comparative Example A1.

<Coating Liquid for Peelable Layer>

Polyester resin: 100 parts
Methyl ethyl ketone: 50 parts
Toluene: 50 parts
   Production Example of a Thermal Transfer Sheet

Prepared was a commercially available thermal transfer sheet formed as follows: a polyethylene terephthalate having a thickness of 6 μm was used as a substrate film, and thereon were successively and repeatedly, in a lateral direction, formed sublimating dye layers in yellow, magenta and cyan, and a heat meltable black ink layer having heat meltable transferability and a black hue. A rear layer was beforehand formed on the back face of the substrate film of this thermal transfer sheet.

Production of a Printed Product

The above-mentioned thermal transfer sheet was used to form thermal transfer images including a photographic tone image 9 based on sublimating transfer and a character image 10 based on melting transfer on the receptor layer of the intermediate transfer recording medium of each of the above-mentioned Examples and Comparative Example by thermal transfer, that is, by use of a thermal transfer printer having a commercially available thermal head mounted. The thermal transfer images were formed at predetermined positions so as to correspond to arrangement shown in FIG. 3. At this stage, the images were formed on the receptor layer so as to have a mirror image relationship with the arrangement shown in FIG. 3.

Thereafter, a commercially available laminator having a permanently-installed heat roll was used to transfer the transferable portion 5 wherein the above-mentioned images were formed onto an entire surface of a transfer-receiving material made of a white PET-G sheet (PET-G, DIAFIXPG-W, manufactured by Mitsubishi Plastics, Inc.) having a thickness of 600 μm, so as to yield a printed product 7 having an arrangement shown in FIG. 3.

When the thermal transfer image was formed onto the receptor layer of each of the intermediate transfer recording media produced in Examples A1 and A2, the peeling strength “a” required for peeling the image formed region of the transferable portion from the substrate film was 104.24392 mN/cm (27 gf/inch) and the peeling strength “b” required for peeling the image non-formed region of the transferable portion from the substrate film was 84.93949 mN/cm (22 gf/inch). Therefore, requirement of the relationship of |a−b|≦b/2 was attained; the difference between the peeling strength “a” and the peeling strength “b”was small; no difference between the image formed region and the image non-formed region of the transferable portion was generated in the surface nature of the transferable portion transferred on the transfer-receiving material; the whole of the transferable portion transferred on the transfer-receiving material was smooth; and the printed product having high glossiness was obtained.

When the thermal transfer image was formed onto the receptor layer of the intermediate transfer recording medium produced in Comparative Example A1, the peeling strength “a” required for peeling the image formed region of the transferable portion from the substrate film was 154.43543 mN/cm (40 gf/inch) and the peeling strength “b” required for peeling the image non-formed region of the transferable portion from the substrate film was 84.93949 mN/cm (22 gf/inch) Therefore, requirement of the relationship of |a−b|≦b/2 could no be attained; the difference between the peeling strength “a” and the peeling strength “b” was large; the surface of the image formed region in the transferable portion was rough after the retransferring; the difference thereof was large and remarkably appeared in comparison with a smooth and highly glossy surface of the image non-formed region; and the product value of the printed product was very low.

Second Aspect of the Present Invention

The intermediate transfer recording medium which according to the second aspect of the present invention is composed of at least a substrate and a transferable portion which is peelably provided on the substrate, the transferable portion having a multilayered structure comprising at least a receptor layer and a peelable layer which is interposed between the receptor layer and the substrate and which facilitates the release of the transferable portion from the substrate,

wherein at the time of peeling the transferable portion from the substrate, the peeling strength of the transferable portion, measured by the peeling test at 180° angles in accordance with JIS Z0237, is from 19.30442 to 96.52215 mN/cm (5 to 25 gf/inch), and the thickness of the transferable portion is 3 μm or less.

The following will describe respective elements which constitute of the intermediate transfer recording medium of the second aspect, referring to FIGS. 1, 2 and 3 common to the description on the first aspect.

The intermediate transfer recording medium of the second aspect can made in the same structure as in the first aspect. That is, the intermediate transfer recording medium of the second aspect basically has a layer structure having a substrate 2 and a transferable portion 5 having a multilayer structure containing at least, on one surface of the substrate 2, a receptor layer 4 and a peelable layer 3 interposed between the receptor layer 4 and the substrate 2. If necessary, other layers may be added thereto. Examples of the other layers include an intermediate layer 6 which may constitute a part of the transferable portion, and a rear layer disposed on the surface of the substrate 2 opposite to the surface on which the transferable portion is present.

The substrate 2, the receptor layer 4, the intermediate layer 6 and the rear layer can be formed in the same way as those in the first aspect. Thus, the second aspect will be described by almost focusing on differences from the first aspect hereinafter.

Peelable Layer:

In the intermediate transfer recording medium of the second aspect, the receptor layer 4 is formed, through at least the peelable layer 3, on the substrate 2 as well as the first aspect. By forming the peelable layer in the intermediate transfer recording medium, the peeling strength with respect to the substrate is appropriately adjusted so that the transferable portion (transferable layer) composed of two or more layers including the receptor layer as a main layer can be surely and easily retransferred from the intermediate transfer recording medium to a transfer-receiving material. When the transferable portion is peeled from the substrate and transferred onto the transfer-receiving material, the peeling is carried out in the boundary between the substrate and the peelable layer in many cases.

The peelable layer essentially has a function of holding the transferable portion on the intermediate transfer recording medium not to be dropped out from the substrate up to the stage at which an image is formed on the receptor layer of the transferable portion by thermal transfer and a function of releasing the transferable portion easily from the substrate at the stage at which the transferable portion is transferred onto a transfer-receiving material after the formation of the image. The peelable layer may have functions other than the above functions.

In the second aspect of the present invention, the peeling strength between the transferable portion and the substrate before an image is formed on the transferable portion of the intermediate transfer recording medium by thermal transfer is set to the range of 19.30442 to 96.52215 mN/cm (5 to 25 gf/inch) when the peeling strength is measured by the peeling test at 180° angles in accordance with JIS Z0237. For the purpose thereof, it is necessary to form a peelable layer made of a release material into which a binder resin may be incorporated as required, so as to enhance the peeling ability of the transferable layer from the substrate.

Examples of the release material preferably used in the second aspect include waxes such as microcrystalline wax, carnauba wax, paraffin wax, Fisher Tropiche wax, various low molecular weight polyethylenes, Japanese wax, beeswax, spermaceti, insect wax, wool wax, shellac wax, candelilla wax, petrolatum, partially-modified wax, aliphatic acid ester, and aliphatic acid amide; silicone waxes; silicone resins; melamine resins; fluorine-contained resins; fine particles such as talc and silica; and lubricants such as surfactants and metal soaps.

As the binder resin which may be added to the release material, various thermoplastic resins or thermosetting resins may be used. Examples of the thermoplastic resins include acrylic resins such as polymethyl methacrylate, polyethyl methacrylate and polybutyl acrylate; vinyl resins such as polyvinyl acetate, vinyl chloride-vinyl acetate copolymer, polyvinyl alcohol and polyvinyl butyral; and cellulose derivatives such as ethylcellulose, nitrocellulose and cellulose acetate. Examples of the thermosetting resins include unsaturated polyester resins; polyester resins; polyurethane resin; and aminoalkyd resins.

The peelable layer can be formed by dissolving or dispersing a material appropriately selected from the above-mentioned materials at an amount also appropriately decided into a suitable solvent to prepare a coating liquid for the peelable layer, applying this liquid to a substrate by gravure printing, screen printing, reverse coating using a gravure plate or some other method, and then drying the same.

The thickness of the peelable layer after the drying is from about 0.05 to 1 μm. Since it is necessary for the intermediate transfer recording medium of the second aspect that the total thickness of the transferable portion comprising at least the peelable layer and the receptor layer is set to 3 μm or less, each of the layers constituting the transferable portion is unavoidably restricted to a smaller thickness than 3 μm.

Transfer-Receiving Material:

In the second aspect, an image can be retransferred without any trouble to the same transfer-receiving material as treated in the above-mentioned first aspect. In particular, when the intermediate transfer recording medium of the second aspect is used, a printed product can be obtained by transferring the transferable portion onto an information-reading section which is beforehand formed in a transfer-receiving material. In this printed product, information recorded in this information-reading section can be read from above the transferable portion without any difficulty.

It is therefore preferable that an information-reading section made of a magnetically recording layer in which information can be magnetically recorded or read or a recording layer in which information can be optically recorded or read is formed beforehand in the transfer-receiving material to which the intermediate transfer recording medium of the second aspect should be applied. In this information-reading section, for example, ID information or information on an owner or money is recorded dependently on the purpose.

In the case that the information-reading section of the transfer-receiving material has a system enabling addition or change of the information to be recorded from above the transferable portion even after covering there with the transferable portion, the information may be not only read but also renewed after the transferable portion is transferred from the intermediate transfer recording medium onto the information-reading section of the transfer-receiving material. Alternatively, new information may be recorded to the information-reading section where information is not recorded at all after the transferable portion is transferred thereto.

In the above-mentioned information-reading section, visible information can be recorded. However, in order to keep a secret or prevent forgery, invisible information is often recorded.

In the case that the transfer-receiving material is provided with, for example, a magnetic stripe having a magnetically recording layer at its information-reading section, there may be used a transfer-receiving material wherein the magnetic stripe appears on a surface of the transfer-receiving material, or a transfer-receiving material wherein a magnetic stripe is formed and further a layer for hiding the stripe is laid thereon so that the magnetic stripe cannot be seen on the transfer-receiving material. This magnetic stripe is used in many cases, that is, the whole of the area where information should be recorded is hidden not to be seen in many cases.

Production of a Printed Product:

An image is formed on the receptor layer of the intermediate transfer recording medium of the second aspect described above by thermal transfer, and then the thermal transfer image, together with the transferable portion including the region where the image is formed (that is, the image formed region) and the region adjacent thereto (that is, the image non-formed region), is retransferred to the transfer-receiving material, whereby a printed product is formed. At this time, it is preferable that an information-reading section is beforehand formed on the transfer-receiving material treated in the second aspect, and the transferable portion is retransferred onto the information-reading section.

It is preferable that the transferable portion of the intermediate transfer recording medium is transferred onto the whole of a receptive surface of the transfer-receiving material, including the information-reading section of the transfer-receiving material.

In the intermediate transfer recording medium of the second aspect, the peeling strength between the transferable portion and the substrate is set to a value in the range of 19.30442 to 96.52215 mN/cm (5 to 25 gf/inch), in terms of the peeling test at 180° angles in accordance with JIS Z0237, and the thickness of the transferable portion is set to 3 μm or less, whereby even if the transferable portion is transferred to cover the information-reading section of the transfer-receiving material, the reading-suitability of the information-reading section does not lower since the layer thickness of the transferable portion is controlled to be a small value and the resistance (peeling strength) of the transferable portion when this part is peeled from the substrate is controlled to be a small value. When the transferable portion is transferred onto the transfer-receiving material, the transferable portion functions as a protective layer. Consequently, damage to the receptive surface of the transfer-receiving material can be prevented.

If the peeling strength is less than 19.30442 mN/cm (5 gf/inch), the transferable portion is liable to be peeled from the substrate during the storage or carriage of the intermediate transfer recording medium. If the peeling strength is more than 96.52215 mN/cm (25 gf/inch), the surface of the transfer-receiving material on which the transferable portion is transferred is rough so that the reading-suitability of the information-reading section lowers.

In the second aspect, the layer thickness of the transferable portion is set to 3 μm or less. If the layer thickness is more than 3 μm, a bad effect is produced on the reading-suitability of the information-reading section of the transfer-receiving material. On the other hand, the lower limit of the layer thickness of the transferable portion is practically about 1 μm since the transferable portion is composed of at least two layers, that is, the receptor layer and the peelable layer.

A colorant is transferred from a colorant layer, such as a dye layer or a heat meltable ink layer of a thermal transfer sheet to any position in the receptor layer of the intermediate transfer recording medium, wherein the transferable portion having a multilayered structure comprising at least the receptor layer and the transferable layer is peelably provided on the substrate, by means of a heating device such as a thermal head. In this way, an image is formed. Next, the image formed in the transferable portion of the intermediate transfer recording medium, together with the transferable portion, is retransferred onto a receptive surface of a transfer-receiving material, in particular an information-reading section as a major part of the receptive surface, by means of a heating device such as a heat roll.

The second aspect is characterized by having particularly satisfactory reading performance or recording performance when the transferable portion in which a thermal transfer image is formed is retransferred from the intermediate transfer recording medium onto the information-reading section of a transfer-receiving material. Therefore, it is preferable to construct a thermal transfer recording system comprising: an intermediate transfer recording medium having a transferable portion wherein the peeling strength thereof from a substrate is from 19.30442 to 96.52215 mN/cm (5 to 25 gf/inch) and the layer thickness thereof is 3 μm or less; and further a transfer-receiving material wherein an information-reading section in which information has not yet been recorded or has already been recorded is beforehand formed.

Variation examples of the second aspect include an intermediate transfer recording medium, a thermal transfer recording system and a thermal transfer recording method which each have not only the characteristics of the second aspect but also the characteristics of the first aspect.

### EXAMPLES B SERIES

The following will describe examples about the second aspect. The word “part(s)” means part(s) by weight.

### Example B1

First, a transparent polyethylene terephthalate having a thickness of 12 μm was used as a substrate film, and the following coating liquid for peelable layer was applied onto the surface of the film with a gravure coater and then dried to form a peelable layer having a thickness of 0.8 μm in a dried state on the entire surface of the substrate film.

<Coating Liquid for Peelable Layer>

Acrylic resin (BR-83, manufactured by Mitsubishi Rayon Co., Ltd.): 88 parts
Polyester resin: 1 part
Polyethylene wax: 11 parts
Methyl ethyl ketone: 50 parts
Toluene: 50 parts

Next, the following coating liquid for receptor layer was applied onto the peelable layer with a gravure coater and then dried to form a receptor layer having a thickness of 1.5 μm a dried state. In this way, an intermediate transfer recording medium of Example B1 was prepared. The layer thickness of the transferable portion of the intermediate transfer recording medium produced in Example B1 was 2.3 μm.

<Coating Layer for Receptor Layer>

Vinyl chloride-vinyl acetate copolymer: 40 parts
Acrylsilicone: 1.5 part
Methyl ethyl ketone: 50 parts
Toluene: 50 parts

Prepared was a commercially available thermal transfer sheet formed as follows: a polyethylene terephthalate film having a thickness of 6 μm was used as a substrate film, and thereon were successively and repeatedly, in a lateral direction, formed sublimating dye layers in yellow, magenta and cyan, and a heat meltable black ink layer having heat meltable transferability and a black hue. A rear layer was beforehand formed on the back face of the substrate film of this thermal transfer sheet.

The above-mentioned thermal transfer sheet was used to form thermal transfer images including a photographic tone image 9 based on sublimating transfer and a character image 10 based on melting transfer on the receptor layer of the resultant intermediate transfer recording medium of Example B1 by thermal transfer, that is, by use of a thermal transfer printer having a commercially available thermal head mounted. The thermal transfer images were formed at predetermined positions so as to correspond to arrangement shown in FIG. 3. At this stage, the images were formed on the receptor layer so as to have a mirror image relationship with the arrangement shown in FIG. 3.

Thereafter, a commercially available laminator having a permanently-installed heat roll was used to transfer the transferable portion 5 wherein the above-mentioned images were formed onto a transfer-receiving material which is a white PET-G sheet (PET-G, DIAFIX PG-W, manufactured by Mitsubishi Plastics, Inc.) having a thickness of 600 μm, one face of which is provided with a magnetic stripe having a magnetically recording layer in which ID information (individual identifying information) was recorded. The transfer was attained onto the whole of the surface including the information-reading section. In this way, a printed product 7 having an arrangement shown in FIG. 3 was yielded.

In the printed product obtained in Example B1, the reading-suitability of the information-reading section based on the magnetic recording was good. In other words, before and after the transfer of the transferable portion, the reading-suitability of the information-reading section, which was determined by means of a reading device (reader checker), did not change and further no apparent damage was observed on the receptive surface of the transfer-receiving material. When the peeling strength between the transferable portion and the substrate film of the intermediate transfer recording medium produced in Example B1 was measured by the peeling test at 180° angles in accordance with JIS Z0237, the value thereof was 57.91329 mN/cm (15 gf/inch).

In the printed product obtained by transferring the transferable portion wherein the thermal transfer image was formed onto the transfer-receiving material wherein the magnetic stripe having the magnetically recording layer in which the ID information (individual identifying information) was recorded was formed, the magnetic stripe appeared on the surface of the transfer-receiving material as illustrated in FIG. 3. However, when there was used a transfer-receiving material wherein a magnetic stripe was formed and further a layer for hiding the magnetic stripe was formed so that the magnetic stripe did not appear on the surface of the transfer-receiving material, the reading-suitability of the information-reading section, based on the magnetic recording, was good in the same manner as described above and no apparent damage was observed on the receptive surface of the transfer-receiving material.

### Comparative Example B1

The same coating liquid for peelable layer as in Example B1 was applied onto the same substrate film as in Example B1 by means of a gravure coater, and then dried to form a peelable layer having a thickness of 2.0 μm after the drying onto the entire surface of the substrate film. Next, the same coating liquid for receptor layer as in Example B1 was applied onto the above-mentioned peelable layer by means of a gravure coater and then dried to form a receptor layer having a thickness of 3.0 μm after the drying. In this way, an intermediate transfer recording medium of Comparative Example B1 was prepared. The layer thickness of the transferable portion of the intermediate transfer recording medium produced in Comparative Example B1 was 5.0 μm.

Prepared was a commercially available thermal transfer sheet formed as follows: a polyethylene terephthalate having a thickness of 6 μm was used as a substrate film, and thereon were successively and repeatedly, in a lateral direction, formed sublimating dye layers in yellow, magenta and cyan, and a heat meltable black ink layer having heat meltable transferability and a black hue. A rear layer was beforehand formed on the back face of the substrate film of this thermal transfer sheet.

The same thermal transfer sheet as in Example B1 was used to form thermal transfer images including a photographic tone image based on sublimating transfer and a character image based on melting transfer on predetermined positions in the receptor layer of the intermediate transfer recording medium of Comparative Example B1 in the same manner as Example B1.

Thereafter, a commercially available laminator having a permanently-installed heat roll was used to transfer the transferable portion wherein the above-mentioned images were formed onto the same transfer-receiving material as used in Example B1 which had a information-reading section provided with a magnetic stripe having a magnetically recording layer in which individual identifying information was recorded. The transfer was attained onto the whole of the surface including the information-reading section of the transfer-receiving material. In this way, a printed product 7 having an arrangement as shown in FIG. 3 was yielded.

In the printed product obtained in Comparative Example B1, the reading-suitability of the information-reading section was good before the transferable portion was transferred. However, after the transferable portion was transferred, no information was able to be read from the information-reading section with a reading device (reader checker). When the peeling strength between the transferable portion and the substrate film of the intermediate transfer recording medium produced in Comparative Example B1 was measured by the peeling test at 180° angles in accordance with JIS Z0237, the value thereof was 57.91329 mN/cm (15 gf/inch).

1. An intermediate transfer recording medium comprising at least a substrate and a transferable portion which is peelably provided on the substrate, the transferable portion having a multilayered structure comprising at least a receptor layer and a peelable layer which is interposed between the receptor layer and the substrate and which facilitates the release of the transferable portion from the substrate,
wherein at the time of peeling the transferable portion from the substrate after forming an image onto the receptor layer of the intermediate transfer recording medium by thermal transfer, the peeling strength of the transferable portion, measured by the peeling test at 180° angles in accordance with JIS Z0237, satisfies a relationship defined by the following inequality (1):

|a−b|≦b/2 (1)
wherein the peeling strength “a” is defined as the peeling strength of an image formed region in the transferable portion and the peeling strength “b” is defined as the peeling strength of an image non-formed region in the transferable portion.

2. The intermediate transfer recording medium according to claim 1, wherein the peelable layer comprises a release material.

3. The intermediate transfer recording medium according to claim 2, wherein the release material is at least one selected from the group consisting of silicone-modified resins and acryl-styrene copolymer resins.

4. An intermediate transfer recording medium comprising at least a substrate and a transferable portion which is peelably provided on the substrate, the transferable portion having a multilayered structure comprising at least a receptor layer and a peelable layer which is interposed between the receptor layer and the substrate and which facilitates the release of the transferable portion from the substrate,
wherein at the time of peeling the transferable portion from the substrate, the peeling strength of the transferable portion, measured by the peeling test at 180° angles in accordance with JIS Z0237, is from 19.30442 to 96.52215 mN/cm (5 to 25 gf/inch), and the thickness of the transferable portion is 3 μm or less.

5. The intermediate transfer recording medium according to claim 4, wherein the peelable layer comprises a release material.

6. The intermediate transfer recording medium according to claim 5, wherein the release material is at least one selected from the group consisting of waxes, silicone waxes, silicone resins, melamine resins, fluorine-contained resins, powders and lubricants.

7. A printed product obtained by forming an image on to the receptor layer of the transferable portion provided to the intermediate transfer recording medium according to claim 4 by thermal transfer, and then transferring the transferable portion including the image onto an information-reading section of a transfer-receiving material.

8. The printed product according to claim 7, wherein the information-reading section is recordable with information from above the transferable portion.
